(19) United States
(12) Patent Application Publication
(10) Pub. No.: US 2013/0036087 A1
(43) Pub. Date: Feb. 7, 2013

(54) VISIBILITY AND MANAGEMENT OF PROJECT DATA

(71) Applicants: Christopher Boyd, Seattle, WA (US); Marius Constantin, Redmond, WA (US)

(72) Inventors: Christopher Boyd, Seattle, WA (US); Marius Constantin, Redmond, WA (US)

(73) Assignee: MICROSOFT CORPORATION, Redmond, WA (US)

(21) Appl. No.: 13/198,835

(22) Filed: Aug. 5, 2011

(51) Int. Cl. G06F 17/30

(52) U.S. Cl. 707/609; 707/E17.005

(57) ABSTRACT

An integrated system for facilitating visibility and management of projects in a Content Management Application (CMA) is provided. A Project Application Server PAS is enabled to coordinate and associate with a CMA and to identify projects, project data, and project task lists associated with the projects processed by the CMA. The PAS may import the projects, the associated project data, and project task lists, into a central database managed by the PAS. The PAS database may also provide a centralized framework for displaying projects and enabling a user to view the projects in order to see activity and content related to a particular project in the centralized PAS framework. The PAS and the CMA may be continuously synchronized in order to maintain current versions of project content as projects are modified by users in the CMA and/or the PAS framework.

### BACKGROUND

Content Management Applications (CMA) and other similar management applications may provide business solutions for collaborating on projects by providing a centralized platform for content, task and document management. The applications may operate over a Web-based framework that allows for users to interact with data in the Content Management Application through a Web browser. A user may create new content for the CMA, and also modify existing content, and documents and other content may be stored, accessed, downloaded, modified and uploaded to the CMA for content sharing using the centralized CMA.

In a content management application, documents, tasks and other content may be stored within the CMA framework. However, the CMA generally may not provide a structured platform for organizing the multiple documents, tasks and project data as part of a project. The CMA further may not provide a platform for viewing a project and the project data associated with the project. The CMA may not provide a way to link or group related documents, tasks and data such that all the content may be viewable as part of a project. Typically, if a user desires to organize all related project content as part of a managed project, the user has to manually locate, select, assign and save the content as part of a managed project in order to organize the content under a managed project. Manually saving multiple documents, tasks and other project content to a project in order to view all of the content and activity associated with a managed project may consequentially be cumbersome, inconvenient and time intensive.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to an integrated system for providing visibility and management of projects in a Content Management Application (CMA). The integrated system may enable a Project Application Server (PAS) to coordinate and associate with a CMA and may allow the PAS to identify projects, project data, and project task lists associated with the projects processed by the CMA. The system may enable the PAS to import the projects, the associated project data, and project task lists, into a central database managed by the PAS. The PAS may store the projects and associated project data/task lists in the central PAS database and organize the associated project data and task lists according to the projects with which they are associated. The PAS database may also provide a centralized framework for displaying both managed and lightweight projects and enabling a user to view the managed and/or lightweight projects in order to see activity and content related to a particular project in the centralized PAS framework. The PAS and the CMA may be continuously synchronized in order to maintain current versions of managed and/or lightweight project content as the projects are modified by users in the CMA and/or the PAS framework.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 demonstrates an example embodiment of an integrated system for project management;

FIG. 2 demonstrates an example embodiment of an integrated system for project management in optional viewing modes;

FIG. 3 demonstrates an example of associating projects in a system for project management according to embodiments;

FIG. 4 demonstrates an example synchronization scenario in an integrated system for project management;

FIG. 5 is a networked environment, where an integrated system according to embodiments may be implemented;

FIG. 6 is a block diagram of an example integrated system environment, where embodiments may be implemented; and

FIG. 7 illustrates a logic flow diagram for a process of associating project data in an integrated system for project management according to embodiments.

### DETAILED DESCRIPTION

As briefly described above, an integrated system for providing visibility and management of projects in a Content Management Application (CMA) using a Project Application Server (PAS). The integrated system may enable a PAS to coordinate and associate with a CMA and may allow the PAS to identify projects, and project data and project task lists associated with the managed and/or lightweight projects contained in the CMA. The system may enable the PAS to import the projects, and the associated project data and project task lists, into a central database contained in the PAS. The PAS may store the projects and associated project data and task lists in the central PAS database and may organize the associated project data and task lists according to the projects with which they are associated. The following detailed description is therefore not to be taken in a limiting sense, and the scope of the present invention is defined by the appended claims and their equivalents.

While the embodiments will be described in the general context of program modules that execute in conjunction with an application program that runs on an operating system on a server or similar computing device, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium can for example be implemented via one or more of a volatile computer memory, a non-volatile memory, a hard drive, a flash drive, a floppy disk, or a compact disk, and comparable media.

Throughout this specification, the term “platform” may be a combination of software and hardware components for facilitating managed and/or lightweight projects through Content Management Applications. Examples of platforms include, but are not limited to, a hosted service executed over a plurality of servers, an application executed on a single computing device, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below.

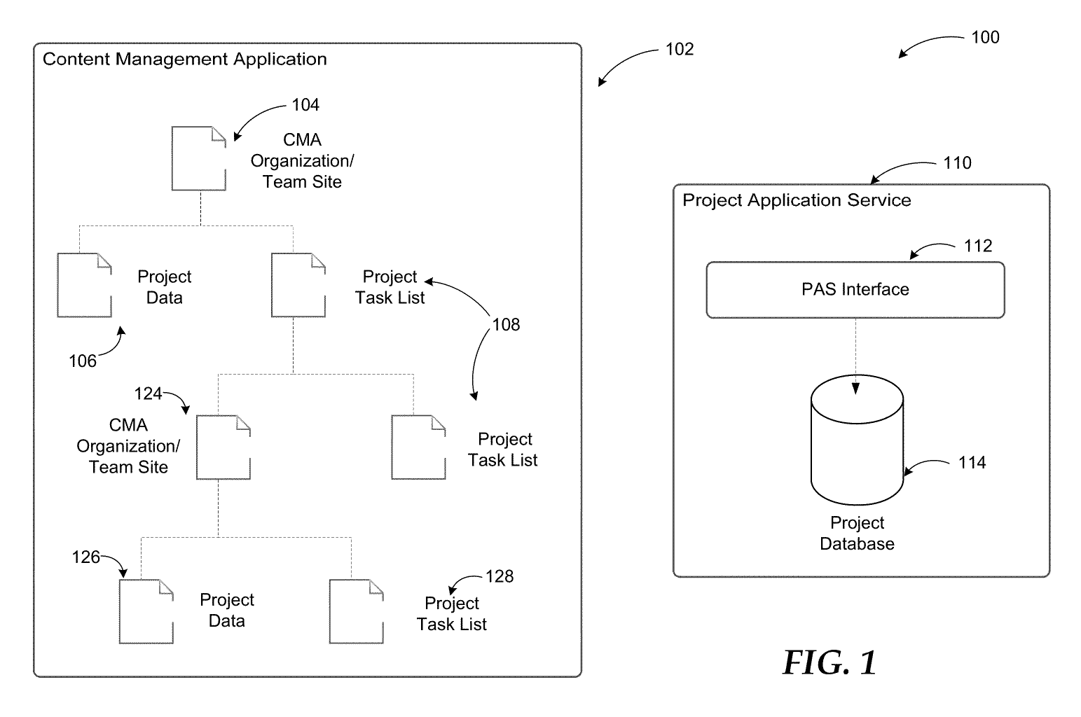

FIG. 1 demonstrates an example embodiment of an integrated system for project management. A Content Management Application (CMA) 102 may enable users and organizations to access a centralized platform for collaboration, as well as content, task, and document management. Documents and other content may be stored, accessed, downloaded, edited and uploaded for content sharing using the centralized CMA, which may be accessible through a web browser or other web based application. The CMA may support multiple organization and team sites 104, 124 for storing project data, documents and tasks associated with each organization and team. Additionally, such an application may be capable of supporting multiple documents, tasks 108, 128, and project data 106, 126 associated with a project and/or associated with organizations and teams.

The CMA 102, however, generally may not provide a structured platform for organizing the multiple documents, tasks and project data as part of a project or for viewing a project and project data associated with the project. For example, the CMA 102 may not provide a way to link or group related documents, tasks and data such that all the content may be viewable as part of a project. Thus, if a user wishes to see all of the content related to a project or tasks occurring under a project, the user may have to manually locate and select the content for viewing, which may be a laborious and time intensive process.

In a system according to embodiments, a Project Application Server (PAS) 110 may provide a centralized location for aggregating project data associated with a project from the CMA 102. The PAS 110 may be coordinated with the CMA 102 in order to import project content 106 from the CMA 102 such that documents, tasks and other project data relating to a project in the CMA 102 may be aggregated and organized in a central location within the PAS 110. The PAS 110 may store the project and its associated content such as documents, tasks and project data in a project database 114 located within the PAS 110. The project database 114 may be synchronized with the CMA to store current versions of project content as the project content is managed and controlled by users using the CMA framework.

In an example embodiment, an interface 112 within the PAS 110 may enable a user to select a project for viewing, and the PAS 110 may enable the user to view all of the content and project data associated with the project, such that the user may see activities that are happening within the project, including associated resources, tasks, calendar items, documents, and other project data. Additionally the PAS 110 may enable full project management functionality, such as for example, enabling a user to open, edit, and modify documents, tasks and project data, and to upload the same to a project stored in the project database 114. Thus in an example embodiment, the PAS 110 may enable visibility of all of the projects and the work happening within each project in a central structured framework.

The example systems in FIG. 1 have been described with specific servers, client devices, applications, and interactions. Embodiments are not limited to systems according to these example configurations. An integrated system providing a for visibility and management of projects in a Content Management Application using a Project Application Server may be implemented in configurations employing fewer or additional components and performing other tasks. Furthermore, specific protocols and/or interfaces may be implemented in a similar manner using the principles described herein.

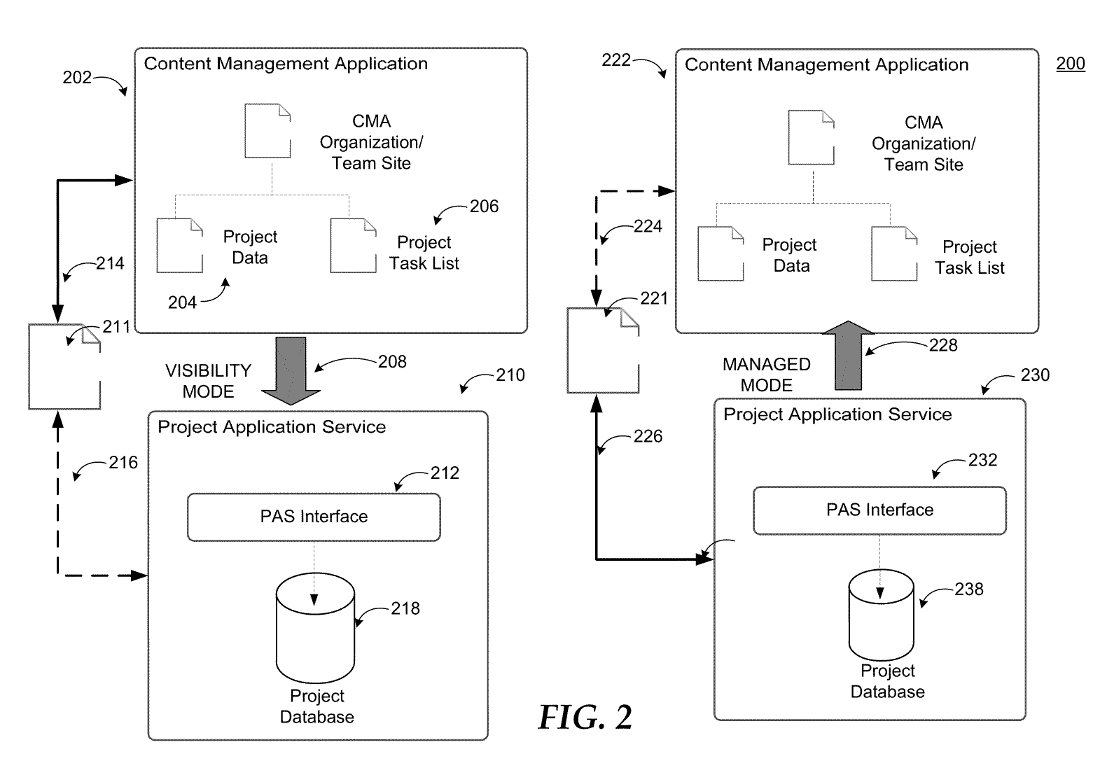

FIG. 2 demonstrates an example embodiment of an integrated system for project management in optional viewing modes, according to embodiments. As described above in conjunction with FIG. 1 the PAS 210 may be coordinated with the CMA 202 in order to import project content from the CMA 202 such that all documents, tasks and other project data relating to a project in the CMA 202 may be aggregated and organized in a central location within the PAS 210. In a system according to embodiments, when the CMA 202 and the PAS 210 become coordinated and associated, the PAS 210 may import the project content, including all project task lists 206 and project data 204 related to the project, into the PAS project database 218.

In a system according to embodiments, after importing the project and related content into the PAS project database 218, the project may be viewed over the interface 212 in two different modes, a visibility mode 208 or a managed mode 228. The visibility mode 208 and the managed mode 228 offer different project viewing features and project control features for project content. For example, in a CMA 202 which has not yet been associated with a PAS 210, users may have full read and write functionality over project content using the tools and features of the CMA 202. Upon association of the CMA 202 with the PAS 210, the PAS 210 may display the project 211 over the PAS interface 212 in the visibility mode 208.

In an example embodiment, while in the visibility mode 208, during an initial association of the PAS with the CMA, the PAS 210 may extract the project data 204 and project task lists 206 from the CMA 202 and import them into the PAS project database 218. The PAS 210 may allow viewing of the project 211 and its associated project data 204 and project task lists 206 over the PAS interface 212. In the visibility mode 208, the CMA 202 may maintain full functionality 214, while the PAS functionality 216 may be disabled. For example, in the visibility mode 208, PAS functionality 216 may be disabled, such that the PAS 210 may allow viewing only of the project 211, and may not enable a user to perform actions on or control the project 211 using the tools and features of the PAS 210. Due to the disabled PAS functionality 216, a user may not be able to make edits in the PAS, perform status checking, or schedule web parts.

In a further embodiment, in the visibility mode 208, the CMA functionality 214 may be fully enabled, such that users may maintain control of a project 211 using the tools and features of the CMA 202. For example, the project task lists 206 in the CMA 202 may maintain its read/write function, and users may create new projects, add to projects, and edit and modify project content using the CMA 202 framework. While the CMA functionality 214 is enabled and the PAS functionality 216 is disabled in the visibility mode, the PAS 210 may continuously coordinate with the CMA 202 to synchronize the PAS project database 218 with the CMA and to update the PAS project database 214 with the current version of the project 211.

In a system according to embodiments, after initial association of the CMA with the PAS, the system may operate in an optional managed mode 228, such that CMA functionality 224 may be disabled while PAS functionality 226 may be enabled. For example, while in the managed mode 228, a user may be able to view and control the project 221 using the PAS 230 framework, and the task list in the CMA 222 may become “read only.” While the PAS functionality 226 is enabled, in the managed mode 228, a user may be able to access a project and its associated documents and project data from the PAS framework for editing and project control.

In a system according to embodiments, in order to preserve project content consistency and to avoid conflicting versions of projects, operating in the managed mode 228, edits and modifications to a project 221 and project data may only be performed using the PAS 230 framework, and the project 221 and its associated project data may be read only in the CMA 222 framework. In an example embodiment, however, the system may enable a user to edit documents or tasks associated with the project using the CMA 222 framework while the system may be in the managed mode 228. In such a scenario, the system may enable a user to “check out” a project 221 in the CMA 222 and open the project 221 in a scheduled web part in the CMA 222 framework. While the project 221 may be “checked out” by a user, the project 221 may become temporarily “read only” in the PAS 230 framework, preventing another user from accessing the project 221 and attempting to modify the project 221 with conflicting project data.

In a system according to embodiments, the system may automatically default to the visibility mode 208 upon initial association of the CMA 202 with the PAS 210. A user may elect to switch to the managed mode 228 to enable full PAS functionality 226 for accessing and modifying the project 221 using the PAS 230 framework. In an example embodiment, the system may enable a user to choose to switch between the visibility mode 208 and the managed mode 228 at any time according to the user's for accessing the project 221.

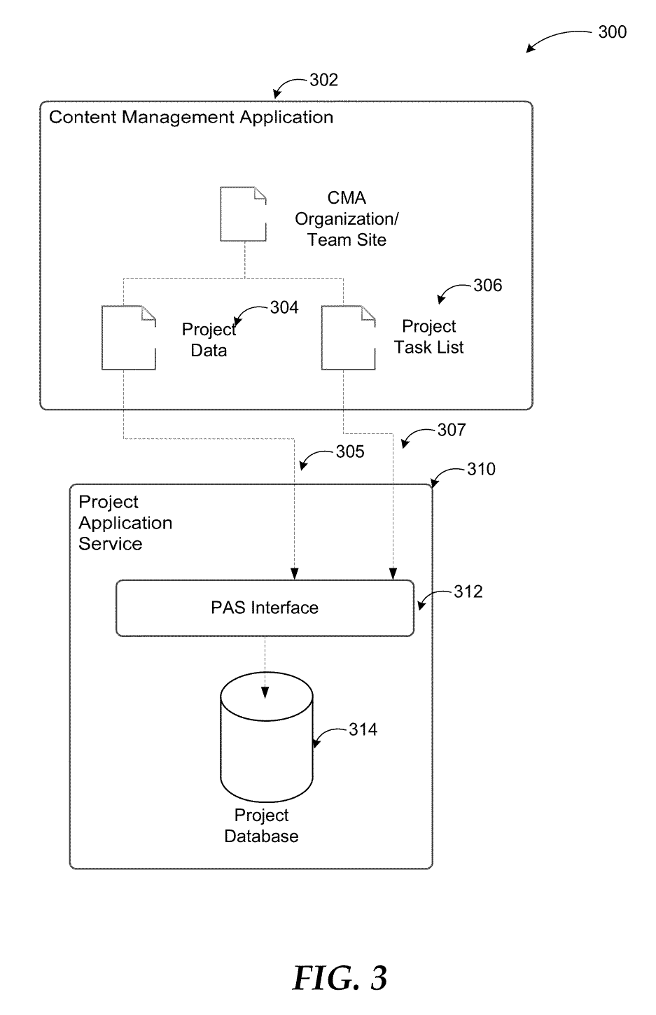

FIG. 3 demonstrates an example of associating projects in a system for project management, according to embodiments. In a system according to embodiments, when a CMA 302 is associated with a PAS 310, the project data 304 and project task lists 306 associated with a project within the existing CMA may be imported into the PAS project database 314. Initial association may be performed manually by a user such that a user may select a project, project data and project task lists for importing into the PAS project database 314. In another embodiment, association may occur automatically upon start up of the PAS 310, which may search the CMA and request to associate with the CMA and synchronize projects and associated content and project data.

In an example embodiment, upon initial association of the PAS 310 with the CMA 302, the PAS 310 may search the CMA 302 for projects, and if projects are identified, the PAS 310 may collect and import 305 the project and its associated project data, documents and project task lists into the PAS project database 314. For example, a project may be identified in the CMA 302 by project name, or by associated tasks. Further, certain project data and documents stored in the CMA 302 may be identified as a part of a project. Upon association, the PAS 310 may import project data 304, documents, and project task lists 306 that have been identified as belonging to or being associated with a particular project. Once imported into the PAS project database 314, project content such as project data, documents and project task lists may be stored and organized according to the project to which they are associated with.

In another example embodiment, if existing project data associated with a project cannot be found in the CMA 302, a new project may be created using the project task lists 306 as the source for the project data. The new project may be imported 307 into the PAS project database 314, along with the project task lists 306 and other project data 304 determined to be associated with the new project. Once project data and project task lists from the CMA 302 have been imported into the PAS project database 314, the association may be complete, and users may have full access to the project using the PAS 310 framework. Users may view the projects stored in the PAS project database 314 over the PAS interface 312, and depending on the viewing mode, the users may additionally have control and project management capabilities over the project in the PAS 310 framework. In a further embodiment, a user may create a PAS profile in order to connect to the PAS 310 for access to the project in the PAS project database 314 and to enable the user to view and edit using the PAS 310 framework.

In a system according to embodiments, while the initial association of the CMA 302 and the PAS 310 occurs, the CMA functionality may remain enabled such that users may access and control projects, project data and project task lists in the CMA 302 framework. As updates and modifications are made to projects, project data and project task lists during the association, the updates may be imported into the PAS project database 314. In an example embodiment, in order to preserve the CMA functionality and performance, the importing and creation of new projects into the PAS project database 314 may not occur rapidly, but may take place steadily over time.

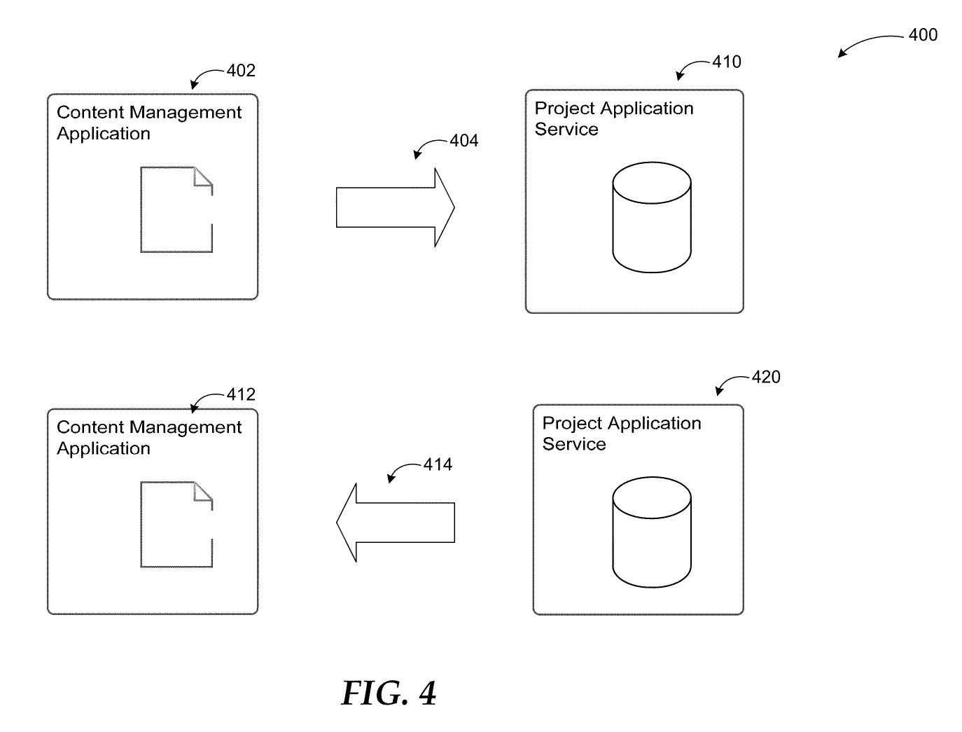

FIG. 4 demonstrates an example synchronization scenario in an integrated system for project management. In a system according to embodiments, after initial association of the CMA 402 with the PAS 410, the system may operate to keep the CMA 402 and the PAS 410 synchronized such that the projects viewed in either the CMA 402 or the PAS 410 consistently reflect most current and identical versions of projects and their associated project data and project task lists.

In a system according to embodiments, the system synchronization may be unidirectional, such that one of the CMA or the PAS may be the default controller, and the other may be synchronized to match the controller. The default controller for the synchronization may depend on the selected viewing mode of the system. For example, when the system operates in the visibility mode 404, the CMA 402 may remain the control for synchronization and the PAS 410 may be synchronized such that the PAS 410 database may reflect the version of the project contained in the CMA 402. Alternatively, when the system operates in the managed mode 414, the PAS 420 may become the control for synchronization and the CMA 412 may be synchronized such that version of the project contained in the CMA 412 matches the version of the project contained in the PAS 420 database.

In a further embodiment, an exception as described above in conjunction with FIG. 2 may occur when the system may enable a user to check out a project in the PAS 420, making the project read only in the PAS 420 while the system operates in the managed mode. During this scenario, when the checked out project in the CMA 412 may be checked back in by a user, the PAS 420 may synchronize with the CMA 412 and the project may be updated in the PAS 420 database to reflect the current version of the updated project saved in the CMA 412.

The examples in FIG. 1-4 have been described with specific elements, configurations, and scenarios. Embodiments are not limited to systems according to these example configurations. An integrated system providing a for visibility and management of projects in a Content Management Application using a Project Application Server may be implemented in configurations using other types of elements, scenarios, and configurations in a similar manner using the principles described herein.

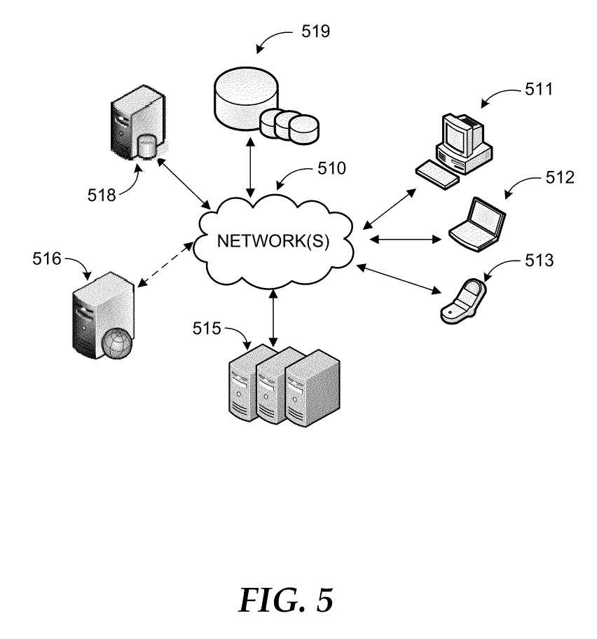

FIG. 5 is an example networked environment, where embodiments may be implemented. An integrated system providing a for visibility and management of projects in a Content Management Application using a Project Application Server may be implemented via software executed over one or more servers 516 such as a hosted service. The platform may communicate with client applications on individual computing devices such as a smart phone 513, a laptop computer 512, or desktop computer 511 (‘client devices’) through network(s) 510.

Client applications executed on any of the client devices 511-513 may facilitate communications via application(s) executed by servers 514, or on individual server 516. A configuration application executed on one of the servers may facilitate a CMA with a PAS for visibility and management of projects. The application may enable users to view a project using the PAS infrastructure and may facilitate the management and control of the project within the PAS framework. The integrated system may retrieve relevant data from data store(s) 519 directly or through database server 518, and provide requested services (e.g. document editing) to the user(s) through client devices 511-513.

Network(s) 510 may comprise any topology of servers, clients, Internet service providers, and communication media. A system according to embodiments may have a static or dynamic topology. Network(s) 510 may include secure networks such as an enterprise network, an unsecure network such as a wireless open network, or the Internet. Network(s) 510 may also coordinate communication over other networks such as Public Switched Telephone Network (PSTN) or cellular networks. Furthermore, network(s) 510 may include short range wireless networks such as Bluetooth or similar ones. Network(s) 510 provide communication between the nodes described herein. By way of example, and not limitation, network(s) 510 may include wireless media such as acoustic, RF, infrared and other wireless media.

Many other configurations of computing devices, applications, data sources, and data distribution systems may be employed to implement a platform providing a for visibility and management of projects in a Content Management Application using a Project Application Server. Furthermore, the networked environments discussed in FIG. 5 are for illustration purposes only. Embodiments are not limited to the example applications, modules, or processes.

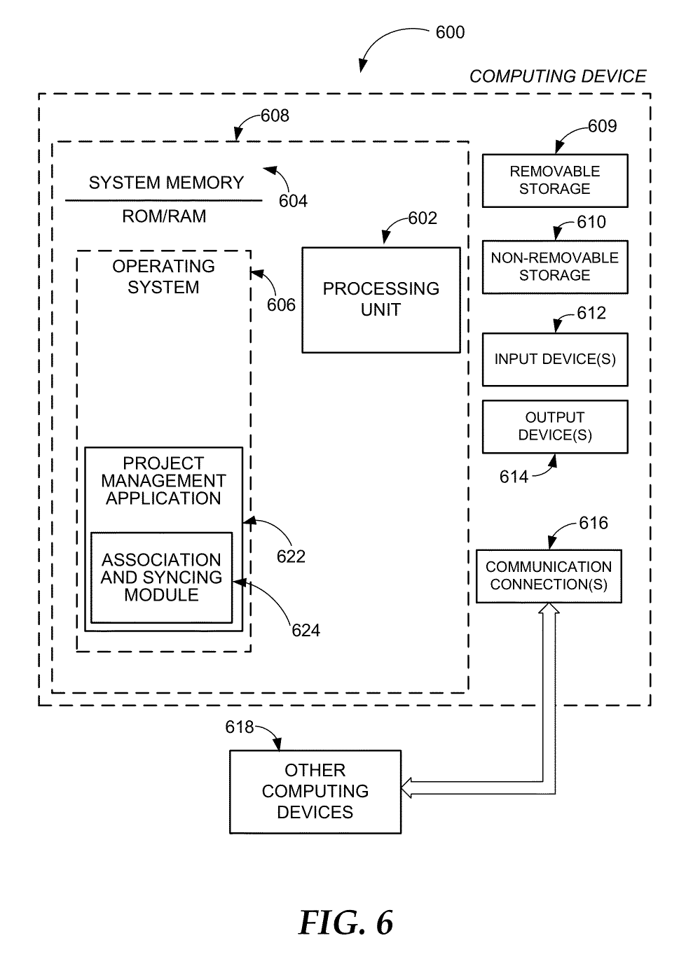

FIG. 6 and the associated discussion are intended to provide a brief, general description of a suitable computing environment in which embodiments may be implemented. With reference to FIG. 6, a block diagram of an example computing operating environment for an application according to embodiments is illustrated, such as computing device 600. In a basic configuration, computing device 600 may be any computing device executing an application capable of facilitating projects in a Content Management Application according to embodiments and include at least one processing unit 602 and system memory 604. Computing device 600 may also include a plurality of processing units that cooperate in executing programs. Depending on the exact configuration and type of computing device, the system memory 604 may be volatile (such as RAM), non-volatile (such as ROM, flash memory, etc.) or some combination of the two. System memory 604 typically includes an operating system 606 suitable for controlling the operation of the platform, such as the WINDOWS ® operating systems from MICROSOFT CORPORATION of Redmond, Wash. The system memory 604 may also include one or more software applications such as project management application 622, and association and syncing module 624.

Project management application 622 may enable users to view, access, modify, manage and control a CMA project using the PAS infrastructure. Through association and syncing module 624, project management application 622 may coordinate and associate the PAS project database with the CMA in order to import and store CMA projects, including project data, documents and project task lists associated with the projects. The association and syncing module 624 may initiate the association and importation of projects, and may enable a particular viewing mode of the system. The association and syncing module 624 may operate to continuously synchronize the PAS project database with the CMA in order to ensure that identical and current versions of projects are displayed in both the CMA and the PAS. Project management application 622 and association and syncing module 624 may be separate applications or integrated modules of a hosted service. This basic configuration is illustrated in FIG. 6 by those components within dashed line 608.

Computing device 600 may have additional features or functionality. For example, the computing device 600 may also include additional data storage devices (removable and/or non-removable) such as, for example, magnetic disks, optical disks, or tape. Such additional storage is illustrated in FIG. 6 by removable storage 609 and non-removable storage 610. Computer readable storage media may include volatile and nonvolatile, removable and non-removable media implemented in any method or technology for storage of information, such as computer readable instructions, data structures, program modules, or other data. System memory 604, removable storage 609 and non-removable storage 610 are all examples of computer readable storage media. Computer readable storage media includes, but is not limited to, RAM, ROM, EEPROM, flash memory or other memory technology, CD-ROM, digital versatile disks (DVD) or other optical storage, magnetic tape, magnetic disk storage or other magnetic storage devices, or any other medium which can be used to store the desired information and which can be accessed by computing device 600. Any such computer readable storage media may be part of computing device 600. Computing device 600 may also have input device(s) 612 such as keyboard, mouse, pen, voice input device, touch input device, and comparable input devices. Output device(s) 614 such as a display, speakers, printer, and other types of output devices may also be included. These devices are well known in the art and need not be discussed at length here.

Computing device 600 may also contain communication connections 616 that allow the device to communicate with other devices 618, such as over a wired or wireless network in a distributed computing environment, a satellite link, a cellular link, a short range network, and comparable mechanisms. Other devices 618 may include computer device(s) that execute communication applications, web servers, and comparable devices. Communication connection(s) 616 is one example of communication media. Communication media can include therein computer readable instructions, data structures, program modules, or other data. By way of example, and not limitation, communication media includes wired media such as a wired network or direct-wired connection, and wireless media such as acoustic, RF, infrared and other wireless media.

Example embodiments also include methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be collocated with each other, but each can be only with a machine that performs a portion of the program.

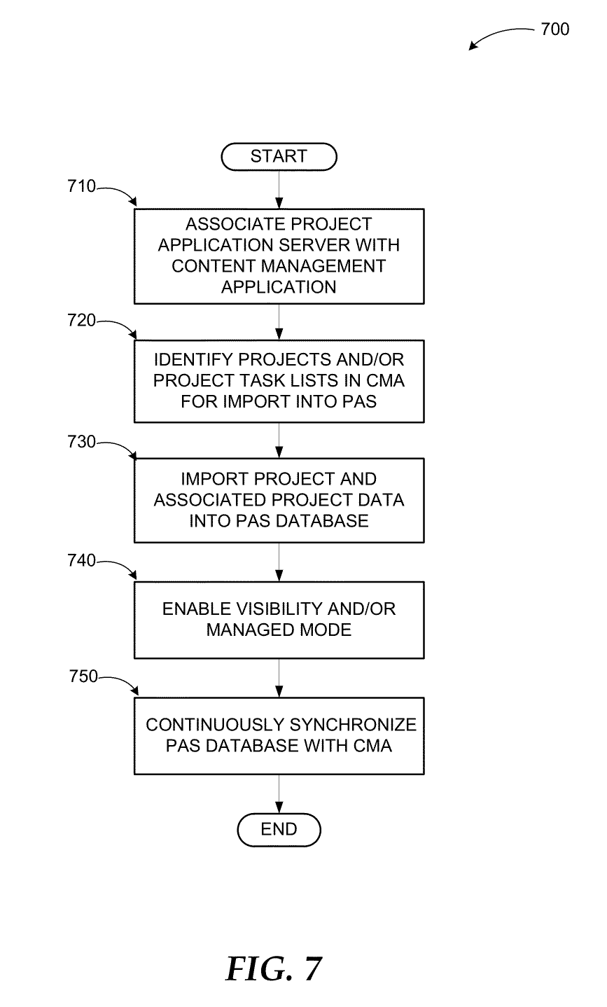

FIG. 7 illustrates a logic flow diagram for process 700 of platform providing a process for importing visibility and management of projects in a Content Management Application using a Project Application Server. Process 700 may be implemented on a server or other computing device.

Process 700 begins with operation 710, where a Project Application Server may be associated with a Content Management application. The PAS may automatically associate with the CMA upon start up of the PAS, which may search the CMA and request to associate with the CMA and synchronize projects and associated content and project data new project may be created in a Project Development Application. In another embodiment, initial association may be performed manually by a user such that a user may select project content for associating with the PAS.

At operation 720, the PAS may identify project data and project task lists for importing into the PAS project database. The PAS may identify projects already created in the CMA, or in an alternative embodiment, the PAS may create a new project using the project task lists as the source for the project. At operation 730 the PAS may import the identified project, including project data, documents, and task lists into the PAS database for storage and organization in the database by project. At operation 740, a viewing mode may be selected for viewing and controlling projects in the PAS. The viewing mode may be one of a visibility mode, in which the projects are read only in the PAS and may be controlled using the CMA infrastructure, or a managed mode, in which the projects may be read only in the CMA and may be managed and controlled using the PAS infrastructure. A user may select the viewing mode and may alternate between the two modes depending on the preferences of the user at any given time.

At operation 750, the PAS and the CMA may be continuously synchronized such that the projects contained in the PAS project database and the CMA may consistently reflect the most current versions of the projects. Depending on the viewing mode of the system, one of the PAS or the CMA may be the control for synchronizing, such that the non-control is synchronized to match the control. For example, in a visibility mode, the PAS may be synchronized to match the CMA, and when in a managed mode, the CMA may be synchronized to match the PAS.

The operations included in process 700 are for illustration purposes. Providing a for visibility and management of projects in a Content Management Application using a Project Application Server may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method executed at least in part in a computing device for providing an integrated system for visibility and management of projects in a Content Management Application (CMA) using a Project Application Server (PAS), the method comprising:
connecting to a CMA;
associating the PAS with the CMA;
identifying one or more projects managed by the CMA;
automatically importing the one or more projects into a PAS database;
enabling a project viewing mode for the one or more projects in the PAS database; and
continuously synchronizing the PAS with the CMA.

2. The method of claim 1, further comprising:
identifying and collecting project data and project task lists associated with the one or more projects from the CMA.

3. The method of claim 2, further comprising:
importing the project data and project task lists associated with one or more projects into the PAS database; and
storing the project data and project task lists according to the one or more projects with which they are associated.

4. The method of claim 1, wherein associating with the CMA further comprises:
automatically associating with the CMA upon start-up of the PAS.

5. The method of claim 1, wherein associating with the CMA further comprises:
enabling a user to manually associate the PAS with the CMA by selecting project data and project task lists for importing into the PAS database.

6. The method of claim 1, wherein enabling the project viewing mode further comprises:
enabling a user to view the one or more projects stored in the PAS database; and
enabling the user to view project data and project task lists associated with each of the one or more projects.

7. The method of claim 1, wherein a project viewing mode includes one of: a visibility mode and a managed mode.

8. The method of claim 7, further comprising:
when the PAS is in the visibility mode:
enabling full functionality, management, and control over the one or projects utilizing CMA infrastructure;
disabling functionality, management, and control over the one or more projects in the PAS database; and
enabling a read-only status for the one or more projects in the PAS database.

9. The method of claim 7, further comprising:
when the PAS is in the managed mode:
enabling full functionality, management, and control over the one or projects in the PAS database utilizing PAS infrastructure;
disabling functionality, management, and control over the one or more projects in the CMA; and
enabling a read-only status for the one or more projects in the CMA.

10. The method of claim 7, further comprising:
enabling a user to select the project viewing mode upon initial association of the PAS with the CMA; and
enabling the user to switch between the visibility mode and the managed mode according to a user preference.

11. The method of claim 7, further comprising:
enabling the one or more projects to be checked-out for editing in the CMA while the managed mode is enabled; and
temporarily disabling PAS functionality while the one or more projects are checked-out for editing in the CMA.

12. The method of claim 7, wherein continuously synchronizing the PAS with the CMA further comprises:
enabling unidirectional synchronization according to the project viewing mode, such that one of the CMA or the PAS is synchronized to match the other at a predefined time point.

13. A server for providing an integrated system for providing visibility and management of projects in a Content Management Application (CMA) using a Project Application Server (PAS), comprising:
a memory storing instructions;
a processor coupled to the memory, the processor executing an integration application, wherein the integration application is configured to:
connect to a CMA;
associate the PAS with the CMA;
identify one or more projects managed by the CMA;
automatically import the one or more projects, project data, and project task lists associated with the one or more projects, into a central project database managed by the PAS;
store the project data and the project task lists according to the one or more projects with which they are associated in the central project database;
enable a project viewing mode for the one or more projects; and
continuously synchronize the PAS with the CMA.

14. The server of claim 13, wherein the project viewing mode includes a visibility mode and a managed mode, and the integration application is further configured to:
in the visibility mode:
enable full functionality, management, and control over the one or projects utilizing CMA infrastructure;
disable functionality, management, and control over the one or more projects in the central project database of the PAS; and
enable a read-only status for the one or more projects in the central project database of the PAS; and
in the managed mode:
enable full functionality, management, and control over the one or projects in the central project database of the PAS utilizing PAS infrastructure;
disable functionality, management, and control over the one or more projects in the CMA; and
enable a read-only status for the one or more projects in the CMA.

15. The server of claim 13, wherein the integration application is further configured to maintain full CMA functionality during initial association of the PAS with the CMA and until import of the one or more projects into the central project database is complete.

16. The server of claim 13, wherein the project data includes at least one from a set of:
user information, tasks, calendar items, and documents associated with the one or more of the projects.

17. The server of claim 13, wherein the integration application is configured to synchronize the PAS with the CMA through one of:
importing updates and modifications to the projects, project data, and project task lists into the central project database during the association; and
importing the updates and modifications into the central project database in a delayed manner.

18. The server of claim 13, wherein the integration application is configured to associate the PAS with the CMA by searching for projects in the CMA that are included in the PAS.

19. A computer-readable storage medium with instructions stored thereon for providing visibility and management of projects in a Content Management Application (CMA) using a Project Application Server (PAS), the instructions comprising:
connecting to a CMA;
associating the PAS with the CMA;
identifying one or more projects managed by the CMA;
automatically importing the one or more projects, project data, and project task lists associated with the one or more projects, into a central project database managed by the PAS;
storing the project data and project task lists according to the one or more projects with which they are associated in the central project database;
enabling one of a visibility mode and a managed mode for viewing the one or more projects; and
continuously synchronizing the PAS with the CMA according to a selected one of the visibility mode and the managed mode.

20. The computer-readable medium of claim 19, wherein the instructions further comprise:
enabling the one or more projects to be checked-out for editing in the CMA while the managed mode is enabled;
temporarily disabling PAS functionality while the one or more projects are checked-out for editing in the CMA; and
upon checking-in of the one or more projects, synchronizing the central project database with the CMA to update the PAS with an edited version of the one or more projects.
